(19) United States
(12) Patent Application Publication
(10) Pub. No.: US 2016/0190642 A1
(43) Pub. Date: Jun. 30, 2016

(54) LITHIUM ION SECONDARY BATTERY, CHARGE-DISCHARGE SYSTEM AND CHARGING METHOD

(71) Applicant: SUMITOMO ELECTRIC INDUSTRIES, LTD., Osaka (JP)

(72) Inventors: Atsushi Fukunaga, Osaka-shi (JP); Koji Nitta, Osaka-shi (JP); Shoichiro Sakai, Osaka-shi (JP); Eiko lmazaki, Osaka-shi (JP); Koma Numata, Osaka-shi (JP)

(21) Appl. No.: 14/911,553

(22) PCT Filed: Apr. 28, 2014
(86) PCT No.: PCT/JP2014/061846

§ 371 Date: Feb. 11, 2016

(30) Foreign Application Priority Data
Aug. 12, 2013 (JP) 2013-167666

(51) Int. Cl. H01M 10/0566; H01M 4/133; H01M 4/525; H01M 4/587; H01M 4/62; H02J 7/00; H01M 4/80; H01M 10/0567; H01M 10/0525; H01M 10/42; H01M 10/44; H01M 4/131; H01M 4/66

(52) U.S. Cl. CPC H01M 10/0566; H01M 4/131; H01M 4/133; H01M 4/525; H01M 4/587; H01M 4/623; H01M 4/625; H01M 4/661; H01M 4/80; H01M 10/0567; H01M 10/0525; H01M 10/4257; H01M 10/443; H02J 7/007; H01M 2004/027

(57) ABSTRACT

A lithium ion secondary battery including a positive electrode, a negative electrode, a separator disposed between the positive electrode and the negative electrode, and a nonaqueous electrolyte, the positive electrode including a positive electrode current collector and a positive electrode active material held on the positive electrode current collector, the positive electrode active material including a lithium-containing transition metal oxide, the negative electrode including a negative electrode current collector and a negative electrode active material held on the negative electrode current collector, the negative electrode active material including at least one selected from the group consisting of lithium metal, lithium alloys, carbon materials, lithium-containing titanium compounds, silicon oxides, silicon alloys, zinc, zinc alloys, tin oxides and tin alloys, the nonaqueous electrolyte including a first salt formed between an organic cation and a first anion and a second salt formed between a lithium ion and a second anion.

### TECHNICAL FIELD

The present invention relates to lithium ion secondary batteries, in particular, to lithium ion secondary batteries suited to be charged and discharged at a high rate.

### BACKGROUND ART

Nonaqueous electrolyte secondary batteries can store electric energy with high energy density and have been recently growing in demand. Of the nonaqueous electrolyte secondary batteries, an active area of research is lithium ion secondary batteries which use as the electrolyte a solution of a lithium salt such as LiPF₆ or LiBF₄ in an organic solvent such as ethylene carbonate. On the other hand, the potential of molten salt batteries using a thermally-stable and flame-retardant molten salt electrolyte has been increasingly recognized. As such a molten salt electrolyte, for example, an ionic liquid that is a salt of an organic cation with an anion is reported (see Patent Literature 1).

### CITATION LIST

### Patent Literature

PTL 1: Japanese Unexamined Patent Application Publication No. 2006-196390

### SUMMARY OF INVENTION

### Technical Problem

In recent years, the use of lithium ion secondary batteries has been expanded even to the storage of electricity for electric vehicles. Such an increase in the range of applications has led to a need for the lithium ion secondary batteries to be enhanced in high-rate charge-discharge properties. It is known, however, that the capacity of lithium ion secondary batteries is decreased when the batteries are operated at a high rate.

### Solution to Problem

An aspect of the present invention resides in a lithium ion secondary battery including a positive electrode, a negative electrode, a separator disposed between the positive electrode and the negative electrode, and a nonaqueous electrolyte, the positive electrode including a positive electrode current collector and a positive electrode active material held on the positive electrode current collector, the positive electrode active material including a lithium-containing transition metal oxide, the negative electrode including a negative electrode current collector and a negative electrode active material held on the negative electrode current collector, the negative electrode active material including at least one selected from the group consisting of lithium metal, lithium alloys, carbon materials, lithium-containing titanium compounds, silicon oxides, silicon alloys, zinc, zinc alloys, tin oxides and tin alloys, the nonaqueous electrolyte including a first salt formed between an organic cation and a first anion and a second salt formed between a lithium ion and a second anion, the proportion of the lithium ions relative to the total of the organic cations and the lithium ions being not less than 20 mol %, the total content of the first salt and the second salt in the nonaqueous electrolyte being not less than 90 mass %.

Another aspect of the present invention resides in a charge-discharge system including the lithium ion secondary battery, a temperature measuring unit that detects the temperature of the lithium ion secondary battery, a charging controller that controls the charging current Iᵢₙ for the lithium ion secondary battery, and a discharging controller that controls the discharging current Iₒᵤₜ for the lithium ion secondary battery, the charging controller being configured to determine the charging current Iᵢₙ in accordance with the temperature of the lithium ion secondary battery detected by the temperature measuring unit.

A still another aspect of the present invention resides in a method for charging the lithium ion secondary battery including a step of detecting the temperature of the lithium ion secondary battery, a step of selecting the charging current Iᵢₙ from at least two preset values of charging current Iᵢₙ₋ₖ (k=1, 2, . . . , ) so that the charging current Iᵢₙ selected has a higher magnitude as the detected temperature is higher, and a step of charging the lithium ion secondary battery at the preset charging current Iᵢₙ₋ₖ selected.

A still another aspect of the present invention resides in a method for discharging the lithium ion secondary battery including a step of detecting the temperature of the lithium ion secondary battery, a step of selecting the discharging current Iₒᵤₜ from at least two preset values of discharging current Iₒᵤₜ₋ₖ (k=1, 2, . . . ) so that the discharging current Iₒᵤₜ selected has a higher magnitude as the detected temperature is higher, and a step of discharging the lithium ion secondary battery at the preset discharging current Iₒᵤₜ₋ₖ selected.

### Advantageous Effects of Invention

The lithium ion secondary batteries can achieve a high capacity even when the batteries are charged and discharged at a high rate.

### BRIEF DESCRIPTION OF DRAWINGS

FIG. 1 is a front view of a positive electrode according to an embodiment of the invention.

FIG. 2 is a sectional view taken along line II-II in FIG. 1.

FIG. 3 is a front view of a negative electrode according to an embodiment of the invention.

FIG. 4 is a sectional view taken along line IV-IV in FIG. 3.

FIG. 5 is a partially cutaway perspective view illustrating a battery case of a molten salt battery according to an embodiment of the invention.

FIG. 6 is a vertical sectional view schematically illustrating a cross section along line VI-VI in FIG. 5.

FIG. 7 is a block diagram schematically illustrating a charge-discharge system according to an embodiment of the invention.

FIG. 8 is a flow diagram illustrating a charge-discharge system according to an embodiment of the invention.

FIG. 9 is a flow diagram illustrating a charge-discharge system according to another embodiment of the invention.

### DESCRIPTION OF EMBODIMENTS

### Description of Embodiments

First, embodiments of the invention will be enumerated.

The first aspect of the present invention resides in (1) a lithium ion secondary battery including a positive electrode, a negative electrode, a separator disposed between the positive electrode and the negative electrode, and a nonaqueous electrolyte, the positive electrode including a positive electrode current collector and a positive electrode active material held on the positive electrode current collector, the positive electrode active material including a lithium-containing transition metal oxide, the negative electrode including a negative electrode current collector and a negative electrode active material held on the negative electrode current collector, the negative electrode active material including at least one selected from the group consisting of lithium metal, lithium alloys, carbon materials, lithium-containing titanium compounds, silicon oxides, silicon alloys, zinc, zinc alloys, tin oxides and tin alloys, the nonaqueous electrolyte including a first salt formed between an organic cation and a first anion and a second salt formed between a lithium ion and a second anion, the proportion of the lithium ions relative to the total of the organic cations and the lithium ions being not less than 20 mol %, the total content of the first salt and the second salt in the nonaqueous electrolyte being not less than 90 mass %.

That is, the nonaqueous electrolyte used in the above embodiment of the invention is a molten salt electrolyte. The molten salt represents not less than 90 mass % of the nonaqueous electrolyte, and the lithium ions represent not less than 20 mol % of the cations present in the nonaqueous electrolyte. With this configuration, the lithium ion secondary battery can achieve excellent rate properties during operation at high temperatures. This effect is specifically obtained when the molten salt electrolyte has a high ion concentration. In the use of an organic electrolytic solution based on an organic solvent as the electrolyte, increasing the amount of a lithium salt is accompanied by an increase in the viscosity of the electrolyte and tends to result in a decrease in high-rate charge-discharge properties. The upper limit of the lithium ion concentration in an electrolyte is considered to be about 2.0 mol/L because of the risk of problems such as the precipitation of a lithium salt.

(2) At least one selected from the first anion and the second anion is preferably a fluorine-containing amide anion. The reason for this is because fluorine-containing amide anions have high heat resistance and high ion conductivity.

(3) The nonaqueous electrolyte preferably includes a carbonate compound. (4) In particular, the nonaqueous electrolyte preferably includes a fluorine-containing carbonate compound. This configuration provides, for example, enhanced intercalation of lithium ions into the negative electrode and a consequent expectation that the rate properties may be further enhanced, because the formation of SEI (solid electrolyte interface) on the electrode is facilitated.

(5) It is preferable that the positive electrode current collector be a porous body of a first metal having a three-dimensional hollow skeleton network structure and the first metal include aluminum. (6) Further, it is preferable that the negative electrode current collector be a porous body of a second metal having a three-dimensional hollow skeleton network structure and the second metal include copper. These configurations allow the negative electrode or positive electrode active material to fill the current collector and to be held thereon in an enhanced manner, and also provide an enhancement in current collecting properties. As a result, a further enhancement in rate properties may be expected.

(7) The second aspect of the present invention resides in a system for charging and discharging the lithium ion secondary battery including the lithium ion secondary battery according to the first aspect, a temperature measuring unit that detects the temperature of the lithium ion secondary battery, a charging controller that controls the charging current Iᵢₙ for the lithium ion secondary battery, and a discharging controller that controls the discharging current Iₒᵤₜ for the lithium ion secondary battery, the charging controller being configured to determine the charging current Iᵢₙ in accordance with the temperature of the lithium ion secondary battery detected by the temperature measuring unit. With this system, the battery may be charged at a current in accordance with the temperature of the battery.

(8) Preferably, the discharging controller is configured to determine the discharging current Iₒᵤₜ in accordance with the temperature of the lithium ion secondary battery detected by the temperature measuring unit. With this system, the battery may be discharged at a current in accordance with the temperature of the battery.

(9) Preferably, the charging current Iᵢₙ is selected from at least two preset values of charging current Iᵢₙ₋ₖ (k=1, 2, . . . ) so that the charging current Iᵢₙ selected has a higher magnitude as the detected temperature is higher. (10) It is also preferable that the discharging current Iₒᵤₜ be selected from at least two preset values of discharging current Iₒᵤₜ₋ₖ (k=1, 2, . . . ) so that the discharging current Iₒᵤₜ selected has a higher magnitude as the detected temperature is higher. These configurations are preferable because the lithium ion secondary battery may be charged and discharged to a high capacity quickly at a high temperature even when the charging and the discharging take place at a high rate.

(11) Preferably, the system further includes a heater that heats the lithium ion secondary battery, and a heating controller that controls the amount of heat supplied from the heater to the lithium ion secondary battery. In the case where the temperature of the lithium ion secondary battery is below a temperature suited for charging and discharging, the temperature may be raised to the appropriate temperature by heating with the heater.

(12) The third aspect of the present invention resides in a method for charging the lithium ion secondary battery including a step of detecting the temperature of the lithium ion secondary battery according to the first aspect, a step of selecting the charging current Iᵢₙ from at least two preset values of charging current Iᵢₙ₋ₖ (k=1, 2, . . . ) so that the charging current Iᵢₙ selected has a higher magnitude as the detected temperature is higher, and a step of charging the lithium ion secondary battery at the preset charging current Iᵢₙ₋ₖ selected.

(13) The fourth aspect of the present invention resides in a method for discharging the lithium ion secondary battery including a step of detecting the temperature of the lithium ion secondary battery according to the first aspect, a step of selecting the discharging current Iₒᵤₜ from at least two preset values of discharging current Iₒᵤₜ₋ₖ (k=1, 2, . . . ) so that the discharging current Iₒᵤₜ selected has a higher magnitude as the detected temperature is higher, and a step of discharging the lithium ion secondary battery at the preset discharging current Iₒᵤₜ₋ₖ selected.

(14) Preferably, the methods further include a step of, when the temperature detected is below a prescribed target temperature, heating the lithium ion secondary battery until the temperature detected (the detected temperature) reaches the target temperature. In this manner, the temperature of the lithium ion secondary battery may be brought to a temperature suited for charging and discharging of the lithium ion secondary battery.

### DETAILED DESCRIPTION OF EMBODIMENTS

Embodiments of the present invention will be described in detail hereinbelow. The scope of the invention is not limited to the embodiments discussed below but is defined by the appended claims and embraces equivalents to the claims and all modifications within the scope of the invention claimed.

### [Nonaqueous Electrolytes]

The nonaqueous electrolyte is a molten salt electrolyte including a first salt formed between an organic cation and a first anion and a second salt formed between a lithium ion and a second anion. The nonaqueous electrolyte is to be liquid at temperatures at which the lithium ion secondary battery is operated. The content of the total of the first salt and the second salt (namely, the molten salt) is not less than 90 mass %, and preferably not less than 92 mass % of the nonaqueous electrolyte. When the content of the molten salt is 90 mass % or more of the nonaqueous electrolyte, heat resistance and nonflammability are further enhanced, and rate properties in charging and discharging at high temperatures are enhanced.

While the molten salt may represent 100 mass % of the nonaqueous electrolyte, the nonaqueous electrolyte may include an organic solvent as an additive in a proportion of not more than 10 mass %, and preferably not more than 8 mass %. A preferred organic solvent is a carbonate compound. Examples of the carbonate compounds include cyclic carbonates such as ethylene carbonate (EC) and propylene carbonate (PC), chain carbonates such as diethyl carbonate (DEC) and dimethyl carbonate (DMC), and fluorine-containing carbonate compounds such as fluoroethylene carbonate. The addition of a carbonate compound or a fluorine-containing carbonate compound facilitates the formation of good SEI on the negative electrode.

The electrochemical reaction between lithium ions and the electrolyte forms a layer called SEI on the negative electrode. The SEI is essential for a negative electrode containing graphite, and it is known that the SEI in a lithium ion secondary battery using an organic electrolytic solution is degraded at a temperature of, for example, 40° C. or above. The degradation of SEI results in a marked decrease in capacity. Thus, a measure is frequently adopted to prevent the temperature increase in the lithium ion secondary battery. In contrast, although the reasons are not clear, the battery of the present embodiment can achieve a high capacity even when charged and discharged at high temperatures.

Examples of the fluorine-containing carbonate compounds include mono-, di- or trifluoroethylene carbonate (FEC), fluoromethyl methyl carbonate, 1,1-difluoromethyl methyl carbonate, and 1,2-difluoromethyl methyl carbonate. In particular, FEC is preferable because good SEI may be formed.

The first salt preferably includes a salt of an organic cation and a fluorine-containing amide anion. The second salt preferably includes a salt of a lithium ion and a fluorine-containing amide anion. These salts are preferable because of their high heat resistance and low viscosity. In particular, the fluorine-containing amide anion preferably has a bis(sulfonyl)amide skeleton and has a fluorine atom on the sulfonyl group because the obtainable nonaqueous electrolyte exhibits high heat resistance and high ion conductivity.

The lithium ion concentration is not less than 20 mol % relative to the cations present in the nonaqueous electrolyte, namely, the total of organic cations and lithium cations. With a lithium ion concentration of 20 mol % or above, a high capacity may be achieved even when the battery is charged and discharged at a high rate. The lithium ion concentration is preferably not less than 25 mol %, and more preferably not less than 30 mol %. The lithium ion concentration is preferably not more than 60 mol %, more preferably not more than 50 mol %, and particularly preferably not more than 45 mol % of the cations present in the nonaqueous electrolyte. Such a nonaqueous electrolyte exhibits low viscosity and makes it easy to achieve a high capacity even when the battery is charged and discharged at a current of a higher rate. The preferred upper and lower limits of the lithium ion concentration may be used in an appropriate combination so as to design a preferred range of the concentration.

Examples of the organic cations include nitrogen-containing cations; sulfur-containing cations; and phosphorus-containing cations. Examples of the nitrogen-containing cations include cations derived from aliphatic amines, alicyclic amines and aromatic amines (for example, quaternary ammonium cations), and organic cations having a nitrogen-containing heterocycle (that is, cations derived from cyclic amines).

Examples of the quaternary ammonium cations include tetraalkylammonium cations (for example, tetra-C₁₋₁₀ alkylammonium cations) such as tetramethylammonium cation, tetraethylammonium cation (TEA⁺), ethyltrimethylammonium cation, hexyltrimethylammonium cation, and methyltriethylammonium cation (TEMA⁺).

Examples of the sulfur-containing cations include tertiary sulfonium cations, for example, trialkylsulfonium cations (for example, tri-C₁₋₁₀ alkylsulfonium cations) such as trimethylsulfonium cation, trihexylsulfonium cation and dibutylethylsulfonium cation.

Examples of the phosphorus-containing cations include quaternary phosphonium cations, for example, tetraalkylphosphonium cations (for example, tetra-C₁₋₁₀ alkylphosphonium cations) such as tetramethylphosphonium cation, tetraethylphosphonium cation and tetraoctylphosphonium cation; and alkyl(alkoxyalkyl)phosphonium cations (for example, tri-C₁₋₁₀ alkyl(C₁₋₅ alkoxy C₁₋₅ alkyl)phosphonium cations) such as triethyl(methoxymethyl)phosphonium cation, diethylmethyl(methoxymethyl)phosphonium cation and trihexyl(methoxyethyl)phosphonium cation. In the alkyl(alkoxyalkyl)phosphonium cations, the total number of the alkyl groups and the alkoxyalkyl groups bonded to the phosphorus atom is 4, and the number of the alkoxyalkyl groups is preferably 1 or 2.

The alkyl groups bonded to the nitrogen atom in the quaternary ammonium cation, the sulfur atom in the tertiary sulfonium cation or the phosphorus atom in the quaternary phosphonium cation each preferably have 1 to 8 carbon atoms, more preferably 1 to 4 carbon atoms, and particularly preferably 1, 2 or 3 carbon atoms.

Here, the organic cation is preferably an organic cation having a nitrogen-containing heterocycle. An ionic liquid that contains an organic cation having a nitrogen-containing heterocycle is a promising molten salt electrolyte because of its high heat resistance and low viscosity. Examples of the nitrogen-containing heterocycle skeletons of the organic cations include 5 to 8-membered heterocycles having 1 or 2 nitrogen atoms in the ring such as pyrrolidine, imidazoline, imidazole, pyridine and piperidine; and 5 to 8-membered heterocycles having 1 or 2 nitrogen atoms, and other heteroatoms (such as oxygen atoms and sulfur atoms) in the ring such as morpholine.

The nitrogen atom constituting the ring may have an organic substituent such as an alkyl group. Examples of the alkyl groups include those alkyl groups having 1 to 10 carbon atoms such as methyl group, ethyl group, propyl group and isopropyl group. The number of the carbon atoms in the alkyl groups is preferably 1 to 8, more preferably 1 to 4, and particularly preferably 1, 2 or 3.

Of the organic cations having a nitrogen-containing heterocycle, those organic cations having a pyrrolidine skeleton are promising nonaqueous electrolytes due to their particularly high heat resistance and low production costs. The organic cations having a pyrrolidine skeleton preferably have two alkyl groups mentioned above on the nitrogen atom constituting the pyrrolidine ring. The organic cations having a pyridine skeleton preferably have one alkyl group mentioned above on the nitrogen atom constituting the pyridine ring. The organic cations having an imidazole skeleton preferably have one alkyl group mentioned above on each of the two nitrogen atoms constituting the imidazole ring.

Specific examples of the organic cations having a pyrrolidine skeleton include 1,1-dimethylpyrrolidinium cation, 1,1-diethylpyrrolidinium cation, 1-ethyl-1-methylpyrrolidinium cation, 1-methyl-1-propylpyrrolidinium cation (MPPY⁺), 1-methyl-1-butylpyrrolidinium cation (MBPY⁺) and 1-ethyl-1-propylpyrrolidinium cation. Of these, those pyrrolidinium cations having a methyl group and an alkyl group with 2 to 4 carbon atoms such as MPPY⁺ and MBPY⁺ are preferable because of their particularly high electrochemical stability.

Specific examples of the organic cations having a pyridine skeleton include 1-alkylpyridinium cations such as 1-methylpyridinium cation, 1-ethylpyridinium cation and 1-propylpyridinium cation. Of these, those pyridinium cations having an alkyl group with 1 to 4 carbon atoms are preferable.

Specific examples of the organic cations having an imidazole skeleton include 1,3-dimethylimidazolium cation, 1-ethyl-3-methylimidazolium cation (EMI⁺), 1-methyl-3-propylimidazolium cation, 1-butyl-3-methylimidazolium cation (BMI⁺), 1-ethyl-3-propylimidazolium cation and 1-butyl-3-ethylimidazolium cation. Of these, those imidazolium cations having a methyl group and an alkyl group with 2 to 4 carbon atoms such as EMI⁺ and BMI⁺ are preferable.

It is preferable that at least one of the first anion and the second anion be a fluorine-containing amide anion. Preferred examples of the fluorine-containing amide anions include those anions having a bis(sulfonyl)amide skeleton and having a fluorine atom on the sulfonyl group. Examples of the fluorine-containing sulfonyl groups include fluorosulfonyl group and sulfonyl groups having a fluoroalkyl group. The fluoroalkyl groups may be such that part of the hydrogen atoms of the alkyl group are replaced by fluorine atoms or may be perfluoroalkyl groups in which all the hydrogen atoms are replaced by fluorine atoms. Preferred fluorine-containing sulfonyl groups are fluorosulfonyl group and perfluoroalkylsulfonyl groups.

Specific examples of the bis(sulfonyl)amide anions include bis(fluorosulfonyl)amide anion [(N(SO₂F)₂⁻)], (fluorosulfonyl)(perfluoroalkylsulfonyl)amide anions [such as (fluorosulfonyl)(trifluoromethylsulfonyl)amide anion ((FSO₂)(CF₃SO₂)N⁻)], and bis(perfluoroalkylsulfonyl)amide anions [such as bis(trifluoromethylsulfonyl)amide anion (N(SO₂CF₃)₂⁻) and bis(pentafluoroethylsulfonyl)amide anion (N(SO₂C₂F₅)₂⁻)]. For example, the perfluoroalkyl groups have 1 to 10 carbon atoms, preferably 1 to 8 carbon atoms, more preferably 1 to 4 carbon atoms, and particularly preferably 1, 2 or 3 carbon atoms. These anions may be used singly, or two or more may be used in combination.

Of the fluorine-containing bis(sulfonyl)amide anions, for example, bis(fluorosulfonyl)amide anion (FSA⁻); (fluorosulfonyl)(perfluoroalkylsulfonyl)amide anion such as (fluorosulfonyl)(trifluoromethylsulfonyl)amide anion; bis(perfluoroalkylsulfonyl)amide anions (PFSA⁻) such as bis(trifluoromethylsulfonyl)amide anion (TFSA⁻) and bis(pentafluoroethylsulfonyl)amide anion are preferable.

Examples of the first anions or the second anions other than the fluorine-containing amide anions include anions of fluorine-containing acids [for example, fluorine-containing phosphate anions such as hexafluorophosphate ion (PF₆⁻); and fluorine-containing borate anions such as tetrafluoroborate ion (BF₄⁻)], anions of chlorine-containing acids [for example, perchlorate ion (ClO₄⁻)], anions of oxalate group-containing oxygen acids [for example, oxalato borate ions such as lithium bis(oxalato)borate ion (B(C₂O₄)₂⁻); and oxalato phosphate ions such as tris(oxalato)phosphate ion (P(C₂O₄)₃⁻)], and fluoroalkanesulfonate anions [for example, trifluoromethanesulfonate ion (CF₃SO₃⁻)].

The first anion and the second anion may be the same as or different from each other. The nonaqueous electrolyte may further include a salt of a metal cation other than the lithium ion such as of sodium, potassium, rubidium or cesium, with an anion. That is, the kinds of the salts constituting the nonaqueous electrolyte are not limited to one or two, and the nonaqueous electrolyte may include three or more kinds of salts or may be a mixture of four or more kinds of salts.

Specific examples of the combinations (molten salts) of the first salt and the second salt include:

(i) a molten salt including a salt of a lithium ion and FSA⁻ (Li.FSA) and a salt of MPPY⁺ and FSA⁻ (MPPY.FSA),

(ii) a molten salt including a salt of a lithium ion and TFSA⁻ (Li.TFSA) and a salt of MPPY⁺ and TFSA⁻ (MPPY.TFSA),

(iii) a molten salt including a salt of a lithium ion and FSA⁻ (Li.FSA) and a salt of EMI⁺ and FSA⁻ (EMI.FSA), and

(iv) a molten salt including a salt of a lithium ion and TFSA⁻ (Li.TFSA) and a salt of EMI⁺ and TFSA⁻ (EMI.TFSA).

### [Positive Electrodes]

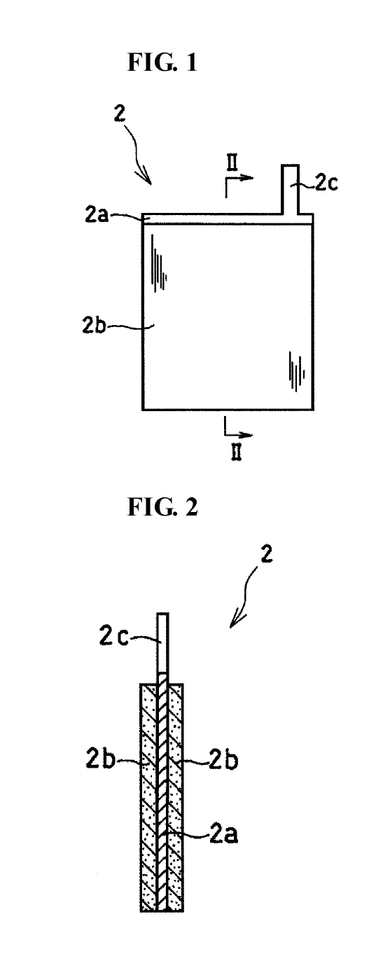

FIG. 1 is a front view of a positive electrode according to an embodiment of the invention. FIG. 2 is a sectional view taken along line II-II in FIG. 1.

A positive electrode 2 includes a positive electrode current collector 2a and a positive electrode active material layer 2b held on the positive electrode current collector 2a. The positive electrode active material layer 2b includes a positive electrode active material as an essential component and may include optional components such as conductive carbon materials and binders.

The positive electrode active material is not limited as long as the material allows lithium ions to be electrochemically intercalated therein and deintercalated therefrom. In this embodiment, a lithium-containing transition metal oxide is used. A single lithium-containing transition metal oxide, or a plurality of such materials may be used. The average particle diameter of the particles of the lithium-containing transition metal oxide is preferably 2 μm to 20 μm.

Specific examples of the lithium-containing transition metal oxides include lithium cobalt oxide, lithium nickel oxide, lithium nickel cobalt oxide (such as LiCo_{0.3}Ni_{0.7}O₂), lithium manganese oxide (LiMn₂O₄) and lithium titanium oxide (Li₄Ti₅O₁₂). Part of the transition metals of these oxides may be substituted by other elements.

Iron phosphates having an olivine structure may be used as the lithium-containing transition metal oxides. Examples of iron phosphates include LiFePO₄ and iron phosphate compounds in which part of iron is substituted by other elements such as transition metal elements and/or typical metal elements (such as LiFe_{0.5}Mn_{0.5}PO₄).

Examples of the conductive carbon materials added to the positive electrodes include graphites, carbon blacks and carbon fibers. Of the conductive carbon materials, carbon blacks are particularly preferable because sufficient conductive paths are easily formed with small amounts of the materials. Examples of the carbon blacks include acetylene black, Ketjen black and thermal black. The amount of the conductive carbon material is preferably 2 to 15 parts by mass, and more preferably 3 to 8 parts by mass with respect to 100 parts by mass of the positive electrode active material.

The binder serves to bind the particles of the positive electrode active material and also to fix the positive electrode active material to the positive electrode current collector. Examples of the binders include fluororesins, polyamides, polyimides and polyamidimides. Examples of the fluororesins include polyvinylidene fluoride (PVDF), polytetrafluoroethylene (PTFE), tetrafluoroethylene-hexafluoropropylene copolymer, and vinylidene fluoride-hexafluoropropylene copolymer. The amount of the binder is preferably 1 to 10 parts by mass, and more preferably 3 to 5 parts by mass with respect to 100 parts by mass of the positive electrode active material.

Examples of the positive electrode current collectors 2a include metal foils, nonwoven fabrics of metal fibers, and metal porous sheets. The metal constituting the positive electrode current collector is not particularly limited but is preferably aluminum or an aluminum alloy because such metals are stable at the positive electrode potential. When an aluminum alloy is used, the amount of the metal component(s) other than aluminum (for example, Fe, Si, Ni and Mn) is preferably not more than 0.5 mass %. The thickness of the metal foil as the positive electrode current collector is, for example, 10 to 50 μm, and the thickness of the metal fiber nonwoven fabric or the metal porous sheet is, for example, 100 to 800 μm, and preferably 100 to 600 μm. In terms of the filling of the collector with the positive electrode active material, the retention of the material and current collecting properties, the positive electrode current collector 2a is preferably a porous body of a first metal having a three-dimensional hollow skeleton network structure and the first metal preferably includes aluminum.

The porous body preferably has communicating holes, and the porosity is preferably 30% to 98%, and more preferably 90 to 98%. Commercially available aluminum porous body “Aluminum-Celmet” (registered trademark) manufactured by Sumitomo Electric Industries, Ltd. may be used.

The aluminum-containing porous body may be obtained by coating the surface of a resin foam or a nonwoven fabric as the base with aluminum or an aluminum alloy and removing the base from the coating layer formed. The resin foams are not particularly limited and any porous resin molded bodies may be used. Examples thereof include urethane foams (polyurethane foams) and styrene foams (polystyrene foams). In particular, urethane foams are preferable because of their high porosity, high uniformity in cell diameters, and excellent thermal degradability. The use of a urethane foam makes it possible to obtain an aluminum-containing porous body having a uniform thickness and excellent surface flatness.

The positive electrode current collector 2a may have a current collecting lead 2c. The lead 2c may be integral with the positive electrode current collector as illustrated in FIG. 1, or a separate lead may be joined to the positive electrode current collector by a method such as welding.

### [Negative Electrodes]

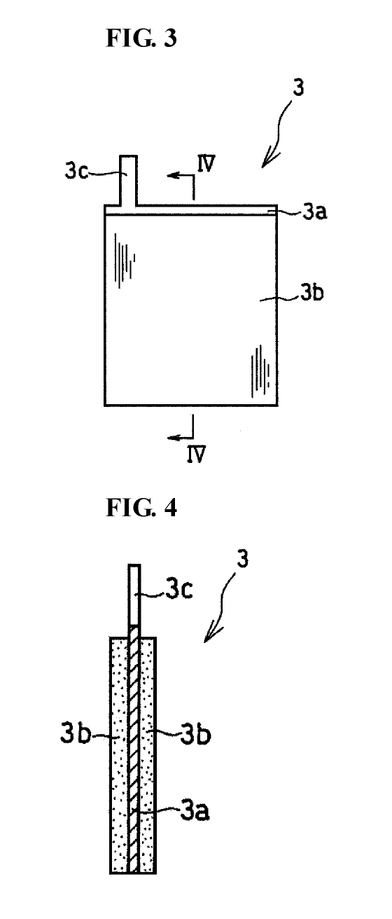

FIG. 3 is a front view of a negative electrode according to an embodiment of the invention. FIG. 4 is a sectional view taken along line Iv-Iv in FIG. 3.

A negative electrode 3 includes a negative electrode current collector 3a and a negative electrode active material layer 3b attached to the negative electrode current collector 3a.

The negative electrode active material forming the negative electrode active material layer 3b may be a metal that is alloyable with lithium or a material that allows lithium ions to be electrochemically intercalated therein and deintercalated therefrom. In this embodiment, at least one selected from the group consisting of lithium metal, lithium alloys, carbon materials, lithium-containing titanium compounds, silicon oxides, silicon alloys, zinc, zinc alloys, tin oxides and tin alloys is used.

When a metal material is used as the negative electrode active material, the negative electrode active material layer 3b may be obtained by, for example, applying or compression-bonding a metal sheet to the negative electrode current collector 3a. Alternatively, the negative electrode active material may be gasified and deposited onto the negative electrode current collector by a gas phase method such as vacuum deposition or sputtering, or metal fine particles may be deposited onto the negative electrode current collector by an electrochemical method such as plating. A gas phase method or a plating method can form a thin and uniform negative electrode active material layer.

A preferred lithium-containing titanium compound is lithium titanium oxide. Specifically, it is preferable to use at least one selected from the group consisting of Li₂Ti₃O₇ and Li₄Ti₅O₁₂. Part of Ti or Li in the lithium titanium oxide may be substituted by other elements. For example, use may be made of Li₂₋ₓM⁵ₓTi_{3-y}M⁶_{y}O₇ (0≦x≦3/2, 0≦y≦8/3, and M⁵ and M⁶ are each independently a metal element other than Ti and Li and are, for example, each independently at least one selected from the group consisting of Ni, Co, Mn, Fe, Al and Cr) and Li₄₋ₓM⁷ₓTi_{5-y}M⁸_{y}O₁₂ (0≦x≦11/3, 0≦y≦14/3, and M⁷ and M⁸ are each independently a metal element other than Ti and Li and are, for example, each independently at least one selected from the group consisting of Ni, Co, Mn, Fe, Al and Cr). The lithium-containing titanium compounds may be used singly, or a plurality thereof may be used in combination. The lithium-containing titanium compounds may be used in combination with non-graphitizable carbons. Incidentally, M⁵ and M⁷ are elements occupying the Li site, and M⁶ and M⁸ are elements occupying the Ti site.

Examples of the carbon materials include graphites, graphitizable carbons (soft carbons) and non-graphitizable carbons (hard carbons). The carbonaceous materials may be used singly, or two or more may be used in combination. From the points of view of thermal stability and electrochemical stability, graphites are particularly preferable. Examples of the graphites include natural graphites (such as flake graphites), artificial graphites and graphitized mesocarbon microbeads. The graphites have a hexagonal crystal structure in which planes of 6-membered carbon rings are two-dimensionally stacked into layers. Lithium ions can easily move in the spaces between the graphite layers and are hence reversibly intercalated into and deintercalated from the graphite.

The negative electrode active material layer 3b may be a mixture layer that includes the negative electrode active material as an essential component and optional components such as binders and conductive carbon materials. Examples of the binders and the conductive carbon materials used in the negative electrodes include those materials mentioned as the components which may constitute the positive electrodes. The amount of the binder is preferably 1 to 10 parts by mass, and more preferably 3 to 5 parts by mass with respect to 100 parts by mass of the negative electrode active material. The amount of the conductive carbon material is preferably 5 to 15 parts by mass, and more preferably 5 to 10 parts by mass with respect to 100 parts by mass of the negative electrode active material.

Examples of the negative electrode current collectors 3a include metal foils, nonwoven fabrics of metal fibers, and metal porous sheets. The metal may be any metal that is not alloyed with lithium. In particular, such metals as copper, copper alloys, nickel and nickel alloys are preferable because these are stable at the negative electrode potential. Preferably, the copper alloys contain less than 50 mass % of elements other than copper, and the nickel alloys contain less than 50 mass % of elements other than nickel. The thickness of the metal foil as the negative electrode current collector is, for example, 10 to 50 μm, and the thickness of the metal fiber nonwoven fabric or the metal porous sheet is, for example, 100 to 600 μm. In terms of the filling of the collector with the negative electrode active material, the retention of the material and current collecting properties, the negative electrode current collector 3a is preferably a porous body of a second metal having a three-dimensional hollow skeleton network structure and the second metal is preferably copper.

The porous body preferably has communicating holes, and the porosity is preferably 30% to 98%, more preferably 80 to 98%, and particularly preferably 90 to 98%.

The porous body of copper may be obtained by coating the surface of a resin foam or a nonwoven fabric as the base with copper and removing the base from the coating layer formed. The resin foam is preferably a urethane foam. Similarly to the aluminum coating layer, the copper coating layer may be formed by a gas phase method such as deposition, sputtering or plasma CVD, or other method such as electrolytic plating. Of these methods, electrolytic plating is preferable.

The negative electrode current collector 3a may have a current collecting lead 3c. The lead 3c may be integral with the negative electrode current collector as illustrated in FIG. 3, or a separate lead may be joined to the negative electrode current collector by a method such as welding.

### [Separators]

A separator may be disposed between the positive electrode and the negative electrode. The material of the separator may be selected in consideration of the temperature at which the battery is used. In order to inhibit side reactions of the separator with the nonaqueous electrolyte, it is preferable to use such materials as glass fibers, silica-containing polyolefins, fluororesins, aluminas and polyphenylene sulfides (PPS). In particular, nonwoven fabrics of glass fibers are preferable because they are inexpensive and have high heat resistance. Further, silica-containing polyolefins and aluminas are preferable because of their excellent heat resistance. Furthermore, fluororesins and PPS are preferable in terms of heat resistance and corrosion resistance. In particular, PPS is highly resistant to fluorine present in the molten salt.

The thickness of the separators is preferably 10 μm to 500 μm, and more preferably 20 to 50 μm. This range of thickness ensures that the occurrence of internal short circuits is effectively prevented and the separator occupies a reduced proportion of the volume of the electrode assembly to make it possible to obtain a high volume density.

### [Electrode Assemblies]

For the lithium ion secondary battery to be used, an electrode assembly including the positive electrode and the negative electrode, and the molten salt electrolyte are accommodated in a battery case. The electrode assembly is formed by stacking or winding the positive electrode and the negative electrode together via the separator. During this process, a metallic battery case may be used and one of the positive electrode and the negative electrode may be placed into electrical continuity to the battery case. In this manner, a portion of the battery case may be used as a first external terminal. The other of the positive electrode and the negative electrode may be connected via a lead or the like to a second external terminal that is insulated from the battery case and extends to the outside of the battery case.

Next, a structure of the lithium ion secondary battery according to an embodiment of the invention will be described. However, the structure of the lithium ion secondary batteries of the invention is not limited to the following.

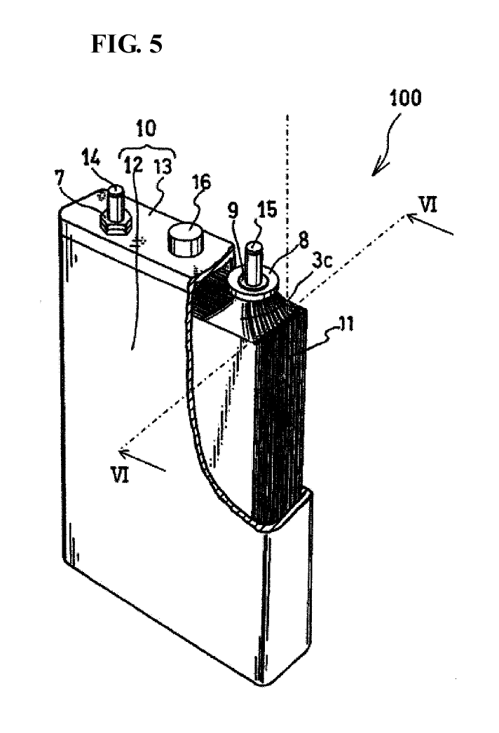

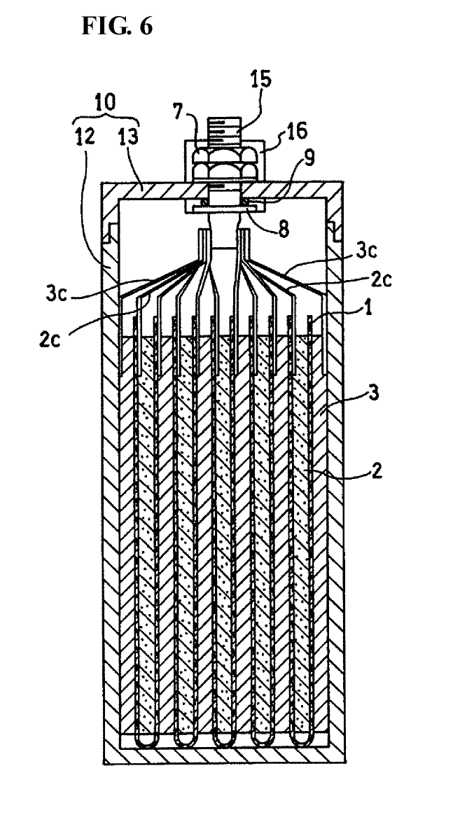

FIG. 5 is a perspective view illustrating a lithium ion secondary battery 100 with a partially cutaway battery case. FIG. 6 is a vertical sectional view schematically illustrating a cross section along line VI-VI in FIG. 5.

The lithium ion secondary battery 100 includes a stacked electrode assembly 11, an electrolyte (not shown) and a square battery case 10 made of aluminum that accommodates the above components. The battery case 10 is composed of a bottomed main body 12 having an opening at its top, and a lid 13 covering the opening. In the assembling of the molten salt battery 100, the electrode assembly 11 is formed first and is inserted into the main body 12 of the battery case 10.

Thereafter, a step is performed in which the molten salt electrolyte is poured into the main body 12 and the spaces between the separators 1, the positive electrodes 2 and the negative electrodes 3 that constitute the electrode assembly 11 are impregnated with the molten salt electrolyte. Alternatively, the electrode assembly may be soaked into the molten salt electrolyte and the electrode assembly wet with the molten salt electrolyte may be inserted into the main body 12.

Near one end of the lid 13, an external positive electrode terminal 14 is disposed which penetrates through the lid 13 while being insulated from the battery case 10. Near the other end of the lid 13, an external negative electrode terminal 15 is disposed which penetrates through the lid 13 while being in electrical continuity to the battery case 10. In the middle of the lid 13, a safety valve 16 is disposed from which a gas generated inside the battery is released to decrease the pressure inside the battery case 10.

The stacked electrode assembly 11 is a collection of rectangular sheets including a plurality of positive electrodes 2, a plurality of negative electrodes 3 and a plurality of separators 1 disposed between the adjacent electrodes. While FIG. 6 illustrates the separators 1 as enveloping the positive electrodes 2, the configuration of the separators is not particularly limited. The plurality of positive electrodes 2 and the plurality of negative electrodes 3 are arranged alternately in the stacking direction in the electrode assembly 11.

A positive electrode lead 2c may be formed on an end of each of the positive electrodes 2. The positive electrode leads 2c of the plurality of positive electrodes 2 are bundled and connected to the external positive electrode terminal 14 disposed on the lid 13 of the battery case 10, thereby connecting the plurality of positive electrodes 2 in parallel. Similarly, a negative electrode lead 3c may be formed on an end of each of the negative electrodes 3. The negative electrode leads 3c of the plurality of negative electrodes 3 are bundled and connected to the external negative electrode terminal 15 disposed on the lid 13 of the battery case 10, thereby connecting the plurality of negative electrodes 3 in parallel. The bundle of the positive electrode leads 2c and the bundle of the negative electrode leads 3c are desirably disposed on the left and the right on one end of the electrode assembly 11 with a space therebetween so as to avoid contact with each other.

The external positive electrode terminal 14 and the external negative electrode terminal 15 are each in the form of a column and have a thread groove in at least a portion exposed to the outside. A nut 7 is brought into engagement with the thread groove of each terminal, and the nut 7 is fixed to the lid 13 by the rotation of the nut 7. Each of the terminals has a collar portion 8 disposed in a portion accommodated inside the battery case. By the rotation of the nut 7, the collar portion 8 is fixed to the inner surface of the lid 13 via a washer 9.

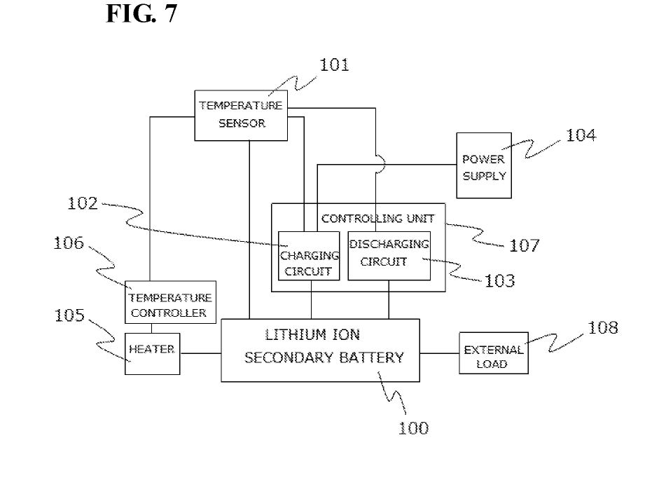

For example, the lithium ion secondary battery may be charged and discharged with a charge-discharge system illustrated in FIG. 7. The charge-discharge system includes the lithium ion secondary battery 100, a temperature measuring unit (a temperature sensor) 101 that detects the temperature of the lithium ion secondary battery 100, and a controlling unit 107 including a charging controller (a charging circuit) 102 that controls the charging current Iᵢₙ for the lithium ion secondary battery 100 and a discharging controller (a discharging circuit) 103 that controls the discharging current Iₒᵤₜ for the lithium ion secondary battery 100. The charging controller determines the charging current Iᵢₙ to be supplied from a power supply 104 in accordance with the temperature of the lithium ion secondary battery 100 detected by the temperature measuring unit 101. Where necessary, the charge-discharge system may include a heater 105 or a cooling device (not shown). The heater 105 preferably includes a heating controller 106 that controls the amount of heat supplied to the lithium ion secondary battery 100. For example, the lithium ion secondary battery 100 is used as a battery for an external load 108 such as an electric vehicle.

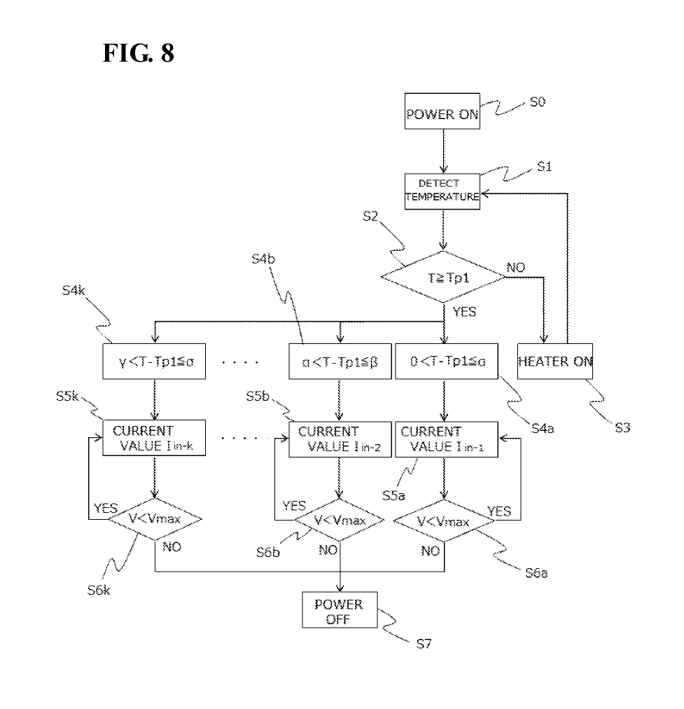

Next, an operation of the system illustrated as an example in FIG. 7 will be described with reference to a flow chart (FIG. 8).

FIG. 8 illustrates an embodiment of the process of controlling the charging current Iₙ. In the present embodiment, the charging start temperature Tp1 is set beforehand, and the charging of the lithium ion secondary battery is started when the temperature T of the lithium ion secondary battery that is detected is higher than Tp1. Magnitudes of charging current Iᵢₙ are preset in accordance with the difference between the detected temperature T and the charging start temperature Tp1.

After a user turns on the power supply 104 (Step 0: S0), the temperature measuring unit (the temperature sensor) 101 detects the temperature of the lithium ion secondary battery 100 (S1). Next, an evaluation is made as to whether the temperature T is equal to or above the charging start temperature Tp1 (S2).

When the temperature is judged to have reached the charging start temperature Tp1, the system measures the excess of the detected temperature T over the charging start temperature Tp1, determines the charging current Iᵢₙ in accordance with the excess, and starts charging of the lithium ion secondary battery. Specifically, when the difference between the charging start temperature Tp1 and the detected temperature T is α° C. or less (S4a), the charging is started at a current Iᵢₙ₋₁ (S5a); when the difference is more than α° C. and not more than β° C. (β>α) (S4b), the charging is started at a current Iᵢₙ₋₂ (>Iᵢₙ₋₁) (S5b). In the present embodiment, the highest charging current Iᵢₙ is a current Iᵢₙ₋ₖ (>Iᵢₙ₋₂) adopted when the difference between the detected temperature T and the charging start temperature Tp1 is more than γ° C. (γ>β) and not more than σ° C. (σ>γ) (S5k). After the battery is charged for a prescribed time, an evaluation is made as to whether the voltage V of the battery 100 has reached the upper-limit voltage Vmax (S6). When the voltage V has reached the upper-limit voltage Vmax, the power supply is turned off (S7) and the charging is completed. When the voltage V is below the upper-limit voltage Vmax, S5 is repeated and the charging is started. The steps 5 and 6 are repeated until the voltage V reaches the upper-limit voltage Vmax. The value of σ is sufficiently large so that the difference between the detected temperature T and the target temperature Tp1 will not exceed σ.

When the detected temperature T is judged to be below the charging start temperature Tp1, the heater 105 is turned on and the lithium ion secondary battery 100 is heated (S3). After the heating, the process starts again from S1 and, when the temperature has reached the charging start temperature Tp1, the lithium ion secondary battery 100 is subjected to the step 4 and the subsequent steps.

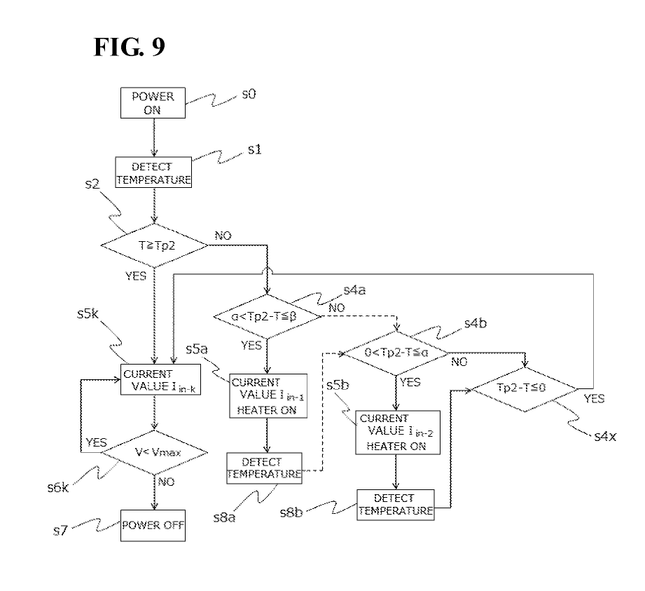

Another embodiment of the process of controlling the charging current Iᵢₙ will be described with reference to FIG. 9. In the present embodiment, the target temperature Tp2 is set beforehand, and the charging of the lithium ion secondary battery is started while performing heating until the temperature T of the lithium ion secondary battery that is detected reaches Tp2. Magnitudes of charging current Iᵢₙ are preset in accordance with the difference between the detected temperature T and the target temperature Tp2.

Similarly to FIG. 8, a user turns on the power supply 104 (Step 0: s0), and the temperature measuring unit (the temperature sensor) 101 detects the temperature of the lithium ion secondary battery 100 (s1). Next, an evaluation is made as to whether the detected temperature T is equal to or above the prescribed target temperature Tp2 (s2).

When the detected temperature T is judged to have reached the target temperature Tp2, the charging of the lithium ion secondary battery is started at a preset current value Iin-k (s5k). After the battery is charged for a prescribed time, an evaluation is made as to whether the voltage V of the battery 100 has reached the upper-limit voltage Vmax (s6k). When the voltage V has reached the upper-limit voltage Vmax, the power supply is turned off (s7) and the charging is completed. When the voltage V is below the upper-limit voltage Vmax, s5k is repeated and the charging is started. The step 5 (s5k) and the step 6 (s6k) are repeated until the voltage V reaches the upper-limit voltage Vmax.

When the detected temperature T is judged to be below the target temperature Tp2, the system measures the difference between the detected temperature T and the target temperature Tp2, determines the charging current Iᵢₙ in accordance with the difference, and starts charging of the lithium ion secondary battery. Specifically, when the difference between the target temperature Tp2 and the detected temperature T is not more than β° C. and more than α° C. (β>α) (s4a), the charging is started at a current Iᵢₙ₋₁ (s5a); when the difference is α° C. or less (s4b), the charging is started at a current Iᵢₙ₋₂ (>Iᵢₙ₋₁) (s5b). In the present embodiment, the heater starts heating at the same time as the start of the charging. The value of β is sufficiently large so that the difference between the detected temperature T and the target temperature Tp2 will not exceed β.

Specifically, when the difference between the target temperature Tp2 and the detected temperature T is not more than β° C. and more than α° C. (β>α) (s4a), the charging is started at a current Iᵢₙ₋₁ while the heater starts to heat the lithium ion secondary battery (s5a). After the passage of a prescribed time, the temperature is detected again (s8a) and, when the difference between the target temperature Tp2 and the temperature T has become α° C. or less, the current value is switched to Iᵢₙ₋₂ and the charging is started at the increased current value. During this process, the heater continues to heat the battery. After the passage of another prescribed time, the temperature is detected again (s8b) and, when the detected temperature T has reached the target temperature Tp2, the process shifts to the step 5 (s5k) and the charging is started at the current value Iᵢₙ₋ₖ (>Iᵢₙ₋₂). That is, the temperature is detected periodically while performing heating until the detected temperature T becomes equal to or exceeds the target temperature Tp2, and the charging is performed while switching the current value to a value appropriate for the detected temperature T. In this manner, the charging time may be reduced.

### [Methods for Charging and Discharging]

By virtue of the use of the specific nonaqueous electrolyte and the high concentration of lithium ions in the electrolyte, the lithium ion secondary battery according to an embodiment of the invention can achieve a high capacity even when charged and discharged at a high rate, for example, when charged at 2 C or above (specifically, 2 to 5 C). Further, the capacity may be enhanced as the battery is charged at a higher temperature. A charging or discharging rate of 2 C means that the current value is such that the charging or discharging of a battery of a nominal rated capacity completes in 0.5 hours.

Specifically, the lithium ion secondary battery according to an embodiment of the invention is charged by, for example, a method including a step of detecting the temperature of the lithium ion secondary battery, a step of selecting the charging current Iᵢₙ from at least two preset values of charging current Iᵢₙ₋ₖ (k=1, 2, . . . ) so that the charging current Iᵢₙ selected has a higher magnitude as the detected temperature is higher, and a step of charging the lithium ion secondary battery at the preset charging current Iᵢₙ₋ₖ selected. The method may further include a step of, when the measured temperature is below the target temperature, heating the lithium ion secondary battery until the temperature reaches the target temperature. The upper limit of the target temperature is preferably 100° C.

Further, the lithium ion secondary battery according to an embodiment of the invention is discharged by, for example, a method including a step of detecting the temperature of the lithium ion secondary battery, a step of selecting the discharging current Tout from at least two preset values of discharging current Iout-k (k=1, 2, . . . ) so that the discharging current Tout selected has a higher magnitude as the detected temperature is higher, and a step of discharging the lithium ion secondary battery at the preset discharging current Iout-k selected. In this case too, the method may further include a step of, when the measured temperature is below the target temperature, heating the lithium ion secondary battery until the temperature reaches the target temperature.

In the above description, the temperature of the battery is the temperature of the surface of the battery.

### EXAMPLES

Next, embodiments of the invention will be described in greater detail based on EXAMPLES. However, EXAMPLES below do not intend to limit the scope of the invention.

### Example 1

### Fabrication of Positive Electrodes

A positive electrode slurry was prepared by dispersing 96 parts by mass of LiCoO₂ (a positive electrode active material) with an average particle diameter of 5 μm, 2 parts by mass of acetylene black (a conductive carbon material) and 2 parts by mass of polyvinylidene fluoride (a binder) in N-methyl-2-pyrrolidone (NMP). The positive electrode slurry was applied to fill an aluminum porous body (Aluminum-Celmet manufactured by Sumitomo Electric Industries, Ltd., thickness 1 mm, porosity 90%) and was dried. The resultant sheet was rolled with a roller press to give a positive electrode with a thickness of 700 μm.

The positive electrode was cut to a 100×100 mm square. Ten sheets of such positive electrodes were prepared. A current collecting lead was formed at an end of a side of each of the positive electrodes.

### (Fabrication of Negative Electrodes)

A negative electrode slurry was prepared by dispersing 97 parts by mass of a graphite powder with an average particle diameter of about 3 μm and 3 parts by mass of polyvinylidene fluoride (a binder) in N-methyl-2-pyrrolidone (NMP). The negative electrode slurry was applied to fill a copper porous body (Copper-Celmet manufactured by Sumitomo Electric Industries, Ltd., thickness 1 mm, porosity 85%) and was dried. The resultant sheet was rolled with a roller press to give a negative electrode with a thickness of 500 μm.

The negative electrode was cut to a 105×105 mm square. Ten sheets of such negative electrodes were prepared. A current collecting lead was formed at an end of a side of each of the negative electrodes.

### (Separators)

A 50 μm thick separator made of a silica-containing polyolefin was provided. The average pore diameter was 0.1 μm and the porosity was 70%. The separator was cut to 110×110 mm, and twenty-one sheets of such separators were prepared.

### (Electrolyte)

A molten salt electrolyte was prepared by mixing Li.FSA and MPPY.FSA together so that the concentration of lithium ions relative to all the cations would be 40 mol %.

### (Assembling of Lithium Ion Secondary Batteries)

The positive electrodes, the negative electrodes and the separators were dried sufficiently by being heated under a reduced pressure of 0.3 Pa at 90° C. or above. Thereafter, an electrode assembly was fabricated by stacking the positive electrodes and the negative electrodes via the separators in such a manner that overlaps were obtained in the positive electrode leads and in the negative electrode leads and also that the bundle of the positive electrode leads and the bundle of the negative electrode leads were arranged at symmetric positions. Thereafter, additional sheets of the separators were arranged at the outsides of both ends of the electrode assembly. The electrode assembly and the separators were placed into the battery case together with the molten salt electrolyte. In this manner, a lithium ion secondary battery A with a nominal capacity of 1.8 Ah which had a structure illustrated in FIGS. 5 and 6 was fabricated.

### Example 2

A lithium ion secondary battery B was fabricated in the same manner as in EXAMPLE 1, except that the electrolyte was changed to a mixture of Li.FSA and EMI.FSA having a lithium ion concentration of 40 mol %.

### Example 3

A lithium ion secondary battery C was fabricated in the same manner as in EXAMPLE 1, except that the electrolyte was changed to one which contained 5 mass % of FEC and the balance of the molten salt prepared in EXAMPLE 1.

### Comparative Example 1

A lithium ion secondary battery a was fabricated in the same manner as in EXAMPLE 1, except that the electrolyte was prepared by adding LiPF₆ to a solvent including EC (50 mass %) and DEC (50 mass %) so that the lithium ion concentration would be 1 mol/L.

### Comparative Example 2

A lithium ion secondary battery b was fabricated in the same manner as in COMPARATIVE EXAMPLE 1, except that LiPF₆ was added so that the lithium ion concentration would be 2.5 mol/L.

### Comparative Example 3

A lithium ion secondary battery c was fabricated in the same manner as in EXAMPLE 1, except that the electrolyte was prepared by mixing Li.FSA and MPPY.FSA together so that the concentration of lithium ions relative to all the cations would be 10 mol %.

### [Evaluation 1]

The lithium ion secondary batteries A, B, C, a, b and c were heated in a thermostatic chamber until their temperature became 25° C. When the temperature stabilized, the batteries were subjected to a cycle of charging and discharging under the conditions (1) and (2) below. The discharge capacities of the lithium ion secondary batteries are described in Tables I to VI.

(1) Charge the battery at a charging current of 0.5 C to a charge cutoff voltage of 3.5 V.

(2) Discharge the battery at a discharging current of 0.5 C to a discharge cutoff voltage of 2.5 V.

Further, the batteries were evaluated in the same manner as in Evaluation 1 at temperatures of 40° C., 60° C. and 90° C. The same evaluation as Evaluation 1 was made while charging and discharging the batteries at current values of 5 C and 10 C. The results are also described in Tables I to VI.

TABLE I
Battery A

Operation temperatures

| Rates | 25° C. | 40° C. | 60° C. | 90° C. |
|---|---|---|---|---|
| 0.5 C | 1.50 mAh | 1.50 mAh | 1.50 mAh | 1.50 mAh |
| 5 C | 1.21 mAh | 1.25 mAh | 1.35 mAh | 1.47 mAh |
| 10 C | 0.84 mAh | 0.96 mAh | 1.17 mAh | 1.38 mAh |

TABLE II
Battery B

Operation temperatures

| Rates | 25° C. | 40° C. | 60° C. | 90° C. |
|---|---|---|---|---|
| 0.5 C | 1.50 mAh | 1.50 mAh | 1.50 mAh | 1.50 mAh |
| 5 C | 1.25 mAh | 1.31 mAh | 1.42 mAh | 1.49 mAh |
| 10 C | 0.92 mAh | 1.09 mAh | 1.32 mAh | 1.42 mAh |

TABLE III
Battery C

Operation temperatures

| Rates | 25° C. | 40° C. | 60° C. | 90° C. |
|---|---|---|---|---|
| 0.5 C | 1.50 mAh | 1.49 mAh | 1.49 mAh | 1.48 mAh |
| 5 C | 1.23 mAh | 1.28 mAh | 1.39 mAh | 1.47 mAh |
| 10 C | 0.87 mAh | 1.05 mAh | 1.26 mAh | 1.40 mAh |

TABLE IV
Battery a

Operation temperatures

| Rates | 25° C. | 40° C. | 60° C. | 90° C. |
|---|---|---|---|---|
| 0.5 C | 1.50 mAh | 1.42 mAh | 1.38 mAh | Could not |
| | | | | be charged |
| 5 C | 1.25 mAh | 1.10 mAh | 0.66 mAh | Could not |
| | | | | be charged |
| 10 C | 0.92 mAh | 0.53 mAh | 0.21 mAh | Could not |
| | | | | be charged |

TABLE V
Battery b

Operation temperatures

| Rates | 25° C. | 40° C. | 60° C. | 90° C. |
|---|---|---|---|---|
| 0.5 C | 1.36 mAh | 1.21 mAh | 1.03 mAh | Could not |
| | | | | be charged |
| 5 C | 0.96 mAh | 0.81 mAh | 0.41 mAh | Could not |
| | | | | be charged |
| 10 C | 0.71 mAh | 0.37 mAh | 0.15 mAh | Could not |
| | | | | be charged |

TABLE VI
Battery c

Operation temperatures

| Rates | 25° C. | 40° C. | 60° C. | 90° C. |
|---|---|---|---|---|
| 0.5 C | 1.50 mAh | 1.50 mAh | 1.50 mAh | 1.50 mAh |
| 5 C | 0.12 mAh | 0.27 mAh | 0.39 mAh | 0.46 mAh |
| 10 C | Could not | 0.08 mAh | 0.15 mAh | 0.21 mAh |
| | be charged | | | |

In general, the rate properties of lithium ion secondary batteries are decreased with increasing temperature at which the batteries are charged and discharged (see the battery a). In contrast, the lithium ion secondary batteries of EXAMPLES 1 to 3 did not show such a dependence on charging and discharging temperatures when the rate was 0.5 C. Further, their rate properties at a higher discharge rate of 5 C or 10 C were enhanced with increasing temperature. This result is in contrast to the fact that the discharge capacity at a high discharge rate is generally decreased due to the occurrence of polarization.

The battery a in which the electrolyte is based on organic solvents could not be charged and discharged under the high-temperature conditions. The battery b having substantially the same lithium ion concentration as the battery A exhibited poor rate properties particularly at high temperatures. The battery c showed rate properties comparable to those of the batteries A to C when the discharge rate was low, but its rate properties were decreased when the discharge rate was increased.

### [Evaluation 2]

The batteries were each subjected to 1000 cycles of charging and discharging under the aforementioned conditions (1) and (2) at 60° C. and at charging and discharging rates of 1 C. The ratio of the discharge capacity in the 1000th cycle to that in the first cycle (the capacity retention rate) was determined.

The results were 90% for the lithium ion secondary battery A, 86% for the battery B, 88% for the battery C, 31% for the battery a, 40% for the battery b, and 63% for the battery c.

### INDUSTRIAL APPLICABILITY

The lithium ion secondary batteries according to the present invention exhibit excellent rate properties when charged and discharged at high temperatures and high rates. Thus, the batteries are useful as power supplies used in the outdoors, for example, in home or industrial large electrical power storage systems, electric vehicles and hybrid vehicles.

### REFERENCE SIGNS LIST

1: SEPARATOR, 2: POSITIVE ELECTRODE, 2a: POSITIVE ELECTRODE CURRENT COLLECTOR, 2b: POSITIVE ELECTRODE ACTIVE MATERIAL LAYER, 2c: POSITIVE ELECTRODE LEAD, 3: NEGATIVE ELECTRODE, 3a: NEGATIVE ELECTRODE CURRENT COLLECTOR, 3b: NEGATIVE ELECTRODE ACTIVE MATERIAL LAYER, 3c: NEGATIVE ELECTRODE LEAD, 7: NUT, 8: COLLAR PORTION, 9: WASHER, 10: BATTERY CASE, 11: ELECTRODE ASSEMBLY, 12: MAIN BODY, 13: LID, 14: EXTERNAL POSITIVE ELECTRODE TERMINAL, 15: EXTERNAL NEGATIVE ELECTRODE TERMINAL, 16: SAFETY VALVE, 100: LITHIUM ION SECONDARY BATTERY, 101: TEMPERATURE MEASURING UNIT, 102: CHARGING CONTROLLER, 103: DISCHARGING CONTROLLER, 104: POWER SUPPLY, 105: HEATER, 106: HEATING CONTROLLER, 107: CONTROLLING UNIT, 108: EXTERNAL LOAD

1. A lithium ion secondary battery comprising a positive electrode, a negative electrode, a separator disposed between the positive electrode and the negative electrode, and a nonaqueous electrolyte,
the positive electrode including a positive electrode current collector and a positive electrode active material held on the positive electrode current collector, the positive electrode active material including a lithium-containing transition metal oxide,
the negative electrode including a negative electrode current collector and a negative electrode active material held on the negative electrode current collector, the negative electrode active material including at least one selected from the group consisting of lithium metal, lithium alloys, carbon materials, lithium-containing titanium compounds, silicon oxides, silicon alloys, zinc, zinc alloys, tin oxides and tin alloys,
the nonaqueous electrolyte including a first salt formed between an organic cation and a first anion and a second salt formed between a lithium ion and a second anion,
the proportion of the lithium ions relative to the total of the organic cations and the lithium ions being not less than 20 mol %,
the total content of the first salt and the second salt in the nonaqueous electrolyte being not less than 90 mass %.

2. The lithium ion secondary battery according to claim 1, wherein at least one selected from the first anion and the second anion is a fluorine-containing amide anion.

3. The lithium ion secondary battery according to claim 1, wherein the nonaqueous electrolyte includes a carbonate compound.

4. The lithium ion secondary battery according to claim 3, wherein the carbonate compound is a fluorine-containing carbonate compound.

5. The lithium ion secondary battery according to claim 1, wherein the positive electrode current collector is a porous body of a first metal having a three-dimensional hollow skeleton network structure and the first metal includes aluminum.

6. The lithium ion secondary battery according to claim 1, wherein the negative electrode current collector is a porous body of a second metal having a three-dimensional hollow skeleton network structure and the second metal includes copper.

7. A charge-discharge system comprising:
the lithium ion secondary battery described in claim 1,
a temperature measuring unit that detects the temperature of the lithium ion secondary battery,
a charging controller that controls the charging current Iᵢₙ for the lithium ion secondary battery, and
a discharging controller that controls the discharging current Iₒᵤₜ for the lithium ion secondary battery,
the charging controller being configured to determine the charging current Iᵢₙ in accordance with the temperature of the lithium ion secondary battery detected by the temperature measuring unit.

8. The charge-discharge system according to claim 7, wherein the discharging controller is configured to determine the discharging current Iₒᵤₜ in accordance with the temperature of the lithium ion secondary battery detected by the temperature measuring unit.

9. The charge-discharge system according to claim 7, wherein the charging current Iᵢₙ is selected from at least two preset values of charging current Iᵢₙ₋ₖ (k=1, 2, . . . ) so that the charging current Iᵢₙ selected has a higher magnitude as the detected temperature is higher.

10. The charge-discharge system according to claim 8, wherein the discharging current Iₒᵤₜ is selected from at least two preset values of discharging current Iₒᵤₜ₋ₖ (k=1, 2, . . . ) so that the discharging current Iₒᵤₜ selected has a higher magnitude as the detected temperature is higher.

11. The charge-discharge system according to claim 7, wherein the system further comprises:
a heater that heats the lithium ion secondary battery, and
a heating controller that controls the amount of heat supplied from the heater to the lithium ion secondary battery.

12. A method for charging a lithium ion secondary battery comprising:
a step of detecting the temperature of the lithium ion secondary battery described in claim 1,
a step of selecting the charging current Iᵢₙ from at least two preset values of charging current Iᵢₙ₋ₖ (k=1, 2, . . . ) so that the charging current Iᵢₙ selected has a higher magnitude as the detected temperature is higher, and
a step of charging the lithium ion secondary battery at the preset charging current Iᵢₙ₋ₖ selected.

13. A method for discharging a lithium ion secondary battery comprising:
a step of detecting the temperature of the lithium ion secondary battery described in claim 1,
a step of selecting the discharging current Iₒᵤₜ from at least two preset values of discharging current Iₒᵤₜ₋ₖ (k=1, 2, . . . ) so that the discharging current Iₒᵤₜ selected has a higher magnitude as the detected temperature is higher, and
a step of discharging the lithium ion secondary battery at the preset discharging current Iₒᵤₜ₋ₖ selected.

14. The method for charging the lithium ion secondary battery according to claim 12, further comprising a step of, when the detected temperature is below a prescribed target temperature, heating the lithium ion secondary battery until the detected temperature reaches the target temperature.

15. The method for discharging the lithium ion secondary battery according to claim 13, further comprising a step of, when the detected temperature is below a prescribed target temperature, heating the lithium ion secondary battery until the detected temperature reaches the target temperature.
